(19) United States
(12) Patent Application Publication
(10) Pub. No.: US 2025/0164932 A1
(43) Pub. Date: May 22, 2025

(54) TIMEPIECE REGULATING MEMBER COMPRISING AN ACTUATION SYSTEM PROVIDED WITH AN ECCENTRIC

(71) Applicant: ETA SA MANUFACTURE HORLOGERE SUISSE, Grenchen (CH)

(72) Inventors: Ivan Villar, Brugg (CH); Pascal Winkler, St-Blaise (CH)

(73) Assignee: ETA SA MANUFACTURE HORLOGERE SUISSE, Grenchen (CH)

(21) Appl. No.: 18/923,996

(22) Filed: Oct. 23, 2024

(30) Foreign Application Priority Data
Nov. 16, 2023 (EP) 23210311.9

(51) Int. Cl. G04B 18/06; G04B 17/06

(52) U.S. Cl. CPC G04B 18/06; G04B 17/06

(57) ABSTRACT

A regulating member (1) for a horological movement including an inertial mass, for example a balance (23), a balance spring (25), a balance cock (22), and an actuation system (20) for adjusting the rate of the balance spring (25), the balance spring (25) including a coiled ribbon (2) and device (30) for adjusting the stiffness of the balance spring, which device is provided with a resilient element (5) arranged in series with the coiled ribbon (2), the adjustment device (30) including a pre-stress device (6) for applying a variable force or torque to the flexible element (5), the actuation system (20) including an eccentric actuating the pre-stress device (6) of the adjustment device (30).

### CROSS-REFERENCE TO RELATED APPLICATIONS

This application claims priority to European Patent Application No. 23210311.9 filed Nov. 16, 2023, the entire contents of which are incorporated herein by reference.

### TECHNICAL FIELD OF THE INVENTION

The invention relates to the field of watchmaking, and more particularly to the field of mechanical watchmaking, where the driving energy is regulated by a regulating member. More specifically, the invention relates to a regulating member provided with a precision actuation system for adjusting the rate of the balance spring, to a horological movement comprising such a regulating member, and to a timepiece comprising such a horological movement.

### TECHNOLOGICAL BACKGROUND

In most mechanical watches, the energy required to rotate the hands (for example the minute and hour hands) is stored in a barrel and then delivered by a sprung balance system, which comprises a flywheel called a balance, combined with a spring in the form of a spirally wound ribbon called a balance spring.

An inside end of the balance spring is attached to a staff that rotates as one with the balance; an outside end of the balance spring is attached to a stud mounted on a stud-holder that is itself rigidly connected to a stationary cock.

The rotation of the balance is maintained—and its oscillations counted—by an escapement mechanism comprising a pallet-lever animated by a low-amplitude oscillating motion, provided with two pallets which engage the teeth of an escape wheel. When the escape wheel is engaged in this way, it is caused to rotate in steps, the frequency of which rotation is determined by the frequency of oscillation of the pallet-lever, which is itself set to the frequency of oscillation of the sprung balance.

In a conventional escapement mechanism, the oscillation frequency is around 4 Hz, or approximately 28,800 vibrations per hour (V/h). One of the objectives of good watchmakers is to ensure the isochronism and regularity of the oscillations (or constancy of rate) of the balance.

The rate of the balance spring can be regulated in a known manner by adjusting the active length of the balance spring, defined as the curvilinear length between its inside end and a counting point, located in the vicinity of the outside end of the balance spring and typically defined by a pair of bankings carried by a key mounted on an index system.

In operation, this index system is not able to rotate about the axis of the balance spring. However, its angular position can be fine-tuned by manual intervention, for example by pivoting an eccentric acting like a cam on the index system using a screwdriver.

The assembly comprising the cock, the index system, the key, the stud-holder, the stud, the staff, the spring and the balance is commonly referred to as the “regulating member”. Examples of regulating members are given in the European patent EP3304215 and in the European patent EP 2 876 504, both filed by the watch manufacturer ETA.

There are index systems which have a stud-holder to which an outside end of the balance spring is attached, and where the index system key leaves play to allow the balance spring to move between the two bankings. However, the chronometric properties, in particular the anisochronism, are very sensitive to play at the index key, and this play is difficult to control precisely.

In some devices, the bankings can be adjusted to clamp the balance spring in order to eliminate play, particularly when the balance spring is in operation. In this case, first the rate is regulated by moving the index key, then clamping the balance spring to the key. However, clamping the balance spring to the index key risks stressing it and creating chronometric errors, in particular due to the off-centring of the windings. Moreover, removing the play also changes the rate, and once the balance spring has been clamped, you can no longer move the index key along the balance spring to finish fine-tuning the rate.

Other balance springs have an integrated regulating device. In these balance springs, the rate is not regulated by altering the effective length of the balance spring, but by applying a force or torque to a resilient element arranged in series with the balance spring. In this way, the stiffness of the resilient element and consequently of the balance spring as a whole can be modified. Adjusting the stiffness of the balance spring allows the rate of the regulating member to be regulated. Such a balance spring provided with a resilient element is described, for example, in the patent application EP4009115.

However, in these cases, usual index systems cannot be used, as they are not compatible with the balance spring regulating device. Moreover, as the rate has to be regulated to a very fine degree, it is essential that there is no play between the balance spring and the areas where it interacts with the index mechanism. More specifically, if this were not the case, there would be a risk of the rate being altered in the event of an impact, if the balance spring does not reposition itself in exactly the same way after the impact.

### SUMMARY OF THE INVENTION

The aim of the present invention is to overcome some or all of the above-mentioned drawbacks by providing an actuation system that is in particular compatible with this type of regulating device.

To this end, the invention relates to a regulating member for a horological movement comprising an inertial mass, for example a balance, a balance spring, a balance cock, and an actuation system for adjusting the rate of the regulating member, the balance spring comprising a coiled ribbon and means for adjusting the stiffness of the balance spring, which means are provided with a resilient element arranged in series with the coiled ribbon, the adjustment means comprising prestressing means for applying a variable force or torque to the flexible element.

The invention is characterised in that the actuation system comprises an eccentric actuating the prestressing means of the adjustment means.

Thanks to the invention, the rate of the regulating member can be adjusted simply by changing the position of the eccentric, which acts on the prestressing means to adjust the rate of the regulating member.

In a particular embodiment of the invention, the eccentric is arranged through the balance cock, whereby the eccentric is rotatably mounted.

In a particular embodiment of the invention, the eccentric comprises a head and a main body extending from the head.

In a particular embodiment of the invention, the body comprises a finger extending from the body, the finger being off-centred relative to the main axis of the main body of the eccentric.

In a particular embodiment of the invention, the head comprises a recess intended to receive the tip of a tool used to actuate the eccentric.

In a particular embodiment of the invention, the prestressing means comprise a first movable lever connected to the flexible element, with the eccentric being in direct or indirect contact with the first lever in order to be able to actuate it.

In a particular embodiment of the invention, the prestressing means comprise a second movable lever connected to the flexible element, with the eccentric being in direct or indirect contact with the second lever in order to be able to actuate it.

In a particular embodiment of the invention, the prestressing means comprise a movable body connected to the first lever and/or to the second lever, with the finger being in contact with the movable body in order to be able to move it.

In a particular embodiment of the invention, the finger comprises a peripheral groove cooperating with the movable body.

In a particular embodiment of the invention, the actuation system comprises a stud-holder comprising a stud on which the balance spring is mounted, the stud being mechanically linked to the resilient element of the balance spring.

In a particular embodiment of the invention, the stud is mechanically linked to the resilient element.

In a particular embodiment of the invention, the stud-holder is arranged on the balance cock around a bearing on the balance staff.

The invention further relates to a horological movement comprising such a regulating member.

The invention further relates to a timepiece, for example a watch, comprising such a horological movement.

### BRIEF DESCRIPTION OF THE FIGURES

The purposes, advantages and features of the present invention will become apparent after reading several embodiments, which are provided for purposes of illustration only and not intended to limit the scope of the invention, given with reference to the accompanying drawings, wherein:

FIG. 1 diagrammatically shows a top view of a regulating member according to a first embodiment of the invention,

FIG. 2 diagrammatically shows a bottom view of the first embodiment of the regulating member shown in FIG. 1,

FIG. 3 diagrammatically shows a sectional, side view taken along the cutting line III, of the first embodiment of the regulating member shown in FIG. 1,

FIG. 4 diagrammatically shows a perspective, disassembled view of the first embodiment of the regulating member shown in FIG. 1, and

FIG. 5 diagrammatically shows a top view of a balance spring of the first embodiment of the regulating member shown in FIG. 1.

### DETAILED DESCRIPTION OF THE INVENTION

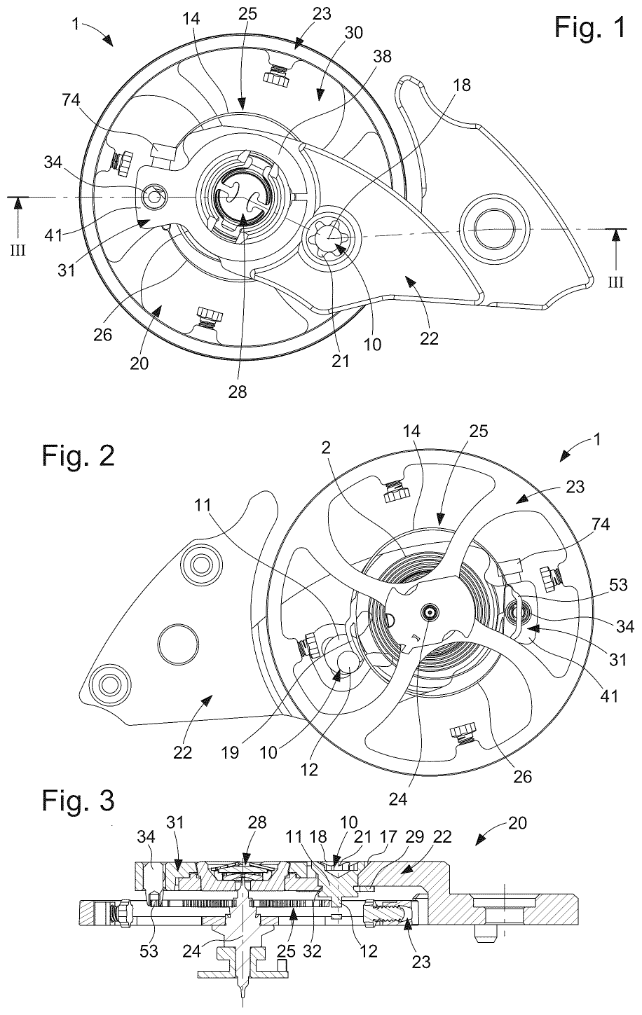

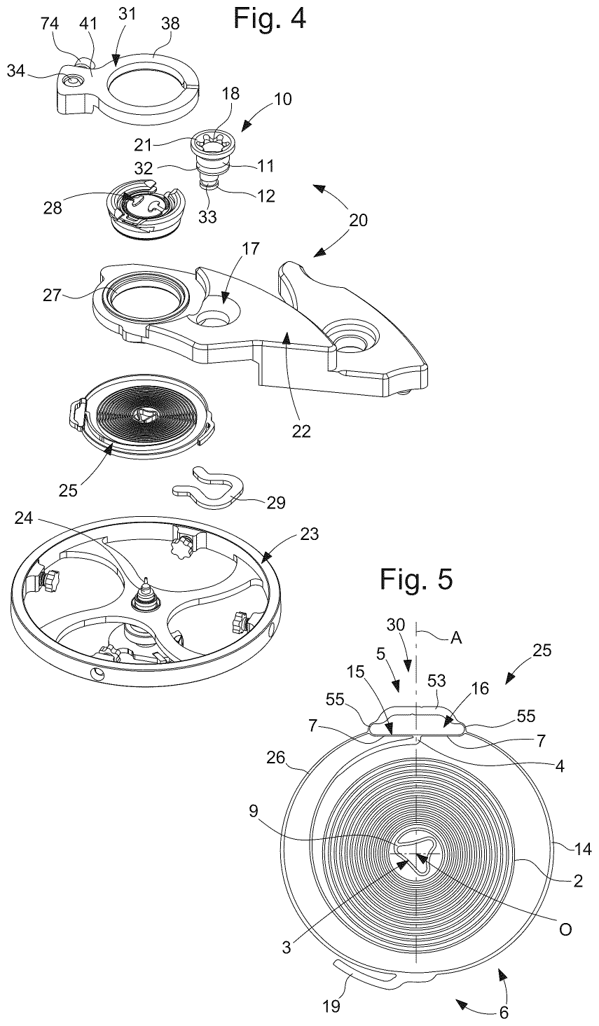

FIGS. 1 to 5 diagrammatically show a first embodiment of a regulating member 1 intended to be arranged in a horological movement not shown in the figures. Such a horological movement comprises, for example, a plate provided with a recess for receiving the regulating member 1, the regulating member 1 being provided with an inertial mass, and a resilient return element for the inertial mass configured to cause it to oscillate.

The regulating member 1 further comprises an actuation system 20, an annular balance 23 as an inertial mass, a balance staff 24, a balance spring 25 as a resilient return element, and a balance cock 22.

In FIGS. 1 to 3, the balance 23, the balance spring 25, the balance cock 22 and the actuation system 20 are stacked, in this case from bottom to top.

The balance staff 24 is centred and passes through the centre of the balance 23, the centre of the balance spring 25 and the balance cock 22. The balance staff 24 is held by two shock-resistant bearings 28 arranged at both ends of the balance staff 24. A first bearing, not shown in the figures, is arranged under the balance 23 and the balance cock 22, and the second bearing 28 is held by the balance cock 22. The balance cock 22 has a hole, in this case a through-hole, inside which the second bearing 28 is held. The actuation system 20 is mounted on the balance cock 22 and is arranged, in this embodiment, along the central axis of the balance staff 24.

FIG. 5 shows an example of a balance spring 25 which preferably extends substantially in one plane. The balance spring 25 comprises a flexible ribbon 2 wound about itself in several turns, the ribbon 2 having a predefined stiffness. The inside end 9 of the ribbon 2 is integral with or assembled with a support 3, typically referred to as a collet. The support 3 is substantially triangular in shape and is threaded around the staff of the balance 24.

The balance spring 25 further includes means 30 for adjusting its stiffness. For example, the adjustment means 30 can in particular be actuated by a user when the regulating member is mounted on the plate of the horological movement.

The adjustment means 30 comprise a flexible element 5 arranged in series with the ribbon 2, with the flexible element 5 connecting one end 4 of said ribbon 2 to a fixed support 53, and integral with one of the ends 4 of the ribbon 2. The flexible element 5 is integral with the outside end 4 of the ribbon 2. The resilient element 5 is a different element from the ribbon 2.

The flexible element 5 adds additional stiffness to that of the ribbon 2. The flexible element 5 is preferably stiffer than the ribbon 2. In this case, the flexible element 5 is arranged as an extension of the ribbon 2. Preferably, the adjustment means and the ribbon 2 are in one piece, or even made of the same material, for example silicon.

In this embodiment of the balance spring, the flexible element 5 comprises two flexible parts 15, 16, each connecting the ribbon 2 to a fixed support 53.

The two flexible parts 15, 16 are arranged, relative to one another, in axial symmetry along an axis A of the balance spring 25. In other words, the two flexible parts 15, 16 are positioned so as to be symmetrical relative to said axis A.

On the one hand, the axis A passes substantially through the centre O of the balance spring, and on the other hand, the axis A preferably passes through the outside end 4 of the ribbon 2.

Thus, the two flexible parts 15, 16 are arranged on the periphery of the balance spring, such that the two flexible parts 15, 16 are arranged at the same distance from the centre O of the balance spring 25.

The two flexible parts 15, 16 are preferably arranged relative to one another in a “mirror-like” position relative to the axis A. To this end, the two flexible parts 15, 16 are preferably substantially identical.

The flexible parts 15, 16 each comprise a curved flexible strip 55, preferably forming a semi-circle, and extending from the end of the fixed support 53. Each curved flexible strip 55 is also connected to the outside end 4 of the ribbon 2 by a main flexible strip 7. In this case, the main flexible strips 7 are arranged in the continuation of one another.

The fixed support 53 has an open trapezoidal shape on the long side towards the outside end 4 of the ribbon 2.

The means for adjusting the balance spring 25 further include prestressing means 6 for applying a variable force or torque to the flexible element 5. In this way, the stiffness of the balance spring can be adjusted. The torque or force is continuously adjustable thanks to the prestressing means 6. In other words, the torque or force is not restricted to isolated values. The stiffness of the flexible element 5 can thus be adjusted with great precision.

Preferably, the prestressing means 6 apply a substantially identical force or torque to each flexible part 15, 16. The directions of the forces are preferably substantially symmetrical relative to the axis A.

The prestressing means 6 further comprise two levers 14, 26, each connecting a curved strip 55 to the same movable body 19 arranged on the other side of the balance spring 25 relative to the fixed support 53. In this case, the movable body 19 is hook-shaped.

The variable force or torque is applied to the movable body 19. The variable force or torque is at least partly transmitted to the main flexible strips 7 of the flexible parts 15, 16 of the flexible element 5, via the levers 26.

In the embodiment shown in FIGS. 1 to 4, the actuation system 20 is fitted with a stud-holder 31 provided with a stud 34.

The stud-holder 31 is in contact with the balance cock 22, and is held and positioned by the shock absorber 28.

During operation of the regulating member 1, the stud-holder 31 is preferably stationary relative to the balance cock 22.

The stud-holder 31 comprises a central ring 38 arranged around the second bearing 28.

The stud-holder 31 comprises a protrusion 41 extending radially from the central ring 38, the protrusion 41 holding the stud 34 down by means of a screw 74.

The stud 34 cooperates with the fixed support 53 of the resilient element 57. The resilient element 5 is thus held by the stud. The balance spring 25 is held on the one hand by the resilient element 5, and on the other hand by the support 3.

The prestressing means 6 are also supported by the stud-holder 31.

The stud and the balance spring 25 are assembled, for example, by bonding, brazing, welding, by deformation of metallic glass, or by mechanical fastening.

In order to be able to apply the variable force or torque to the balance spring 25, the regulating member comprises an actuation system 20.

According to the invention, the actuation system 20 comprises a rotatable eccentric 10 which co-operates with the balance spring 25 to modify its stiffness.

The eccentric 10 comprises a head 21 provided with a recess 18 for receiving the tip of a tool for adjusting the eccentric 10. The eccentric 10 has a main body 11 that is preferably cylindrical, extending from the head 21.

The eccentric 10 further comprises a finger 12 that is off-centred relative to the main axis of the main body 11 of the eccentric 10. The finger 12 extends from the main body 11. The finger 12 is mechanically linked to the prestressing means 6, but does not block the ribbon 2.

The eccentric 10 is arranged through the balance cock 22. The balance cock 22 comprises a flared through-hole 17, so as to retain the head 21 of the eccentric 10, and allow the body 11 and the finger 12 to pass through to the other side of the balance cock 22.

The eccentric 10 is held by a clamp 29 clipped around the main body 11 of the eccentric 10 below the balance cock 22.

Preferably, the main body 11 comprises a groove 32 into which the clamp 29 is inserted to retain the eccentric 10 in the hole 17.

The eccentric 10 is rotatably mounted in the balance cock 22. It can thus rotate in the hole 17 and in the clamp 29 about the main axis of the eccentric 10, preferably substantially perpendicularly to the balance cock 22 and/or substantially parallel to the balance staff 24.

The finger 12 of the eccentric 10 is in contact with the movable body 19 of the prestressing means 6 to be able to push the levers 14, 26 more or less strongly when the eccentric 10 is rotated.

Preferably, the finger 12 comprises a peripheral groove 33 cooperating with the movable body 19 of the balance spring 25, the movable body 19 being inserted into the groove 33.

Thus, when the eccentric 10 is rotated, the finger 12 presses more or less on the movable body 19, because the finger is eccentric relative to the main axis of rotation of the eccentric 10.

The movement of the finger 12 against the movable body modifies the stiffness of the resilient element 5, as the movement exerts a greater or lesser force or torque on the movable body 19 of the prestressing means 6, so that the stiffness of the flexible parts 15, 16 of the resilient element 5 varies, via the levers 26, and thus the stiffness of the balance spring 25 as a whole also varies. The actuation system 20 thus allows the rate of the regulating member 1 to be regulated.

To this end, the actuation system 20 can be used to modify the position of the finger 12.

The actuation system 20 is configured to adjust the rate of the regulating member 1 with a resolution of less than or equal to 1 second per day, preferably less than or equal to 0.5 seconds per day, or even less than or equal to 0.1 seconds per day. The configuration of the regulating member 1 allows such precision to be achieved.

It goes without saying that the invention is not limited to the embodiment of the regulating member described with reference to the figures and alternatives can be considered without leaving the scope of the invention.

1. A regulating member (1) for a horological movement comprising a balance, a balance spring (25), a balance cock (22), and an actuation system (20) for adjusting the rate of the balance spring (25), the balance spring (25) comprising a coiled ribbon (2) and means (30) for adjusting the stiffness of the balance spring, which means are provided with a resilient element (5) arranged in series with the coiled ribbon (2), the adjustment means (30) comprising prestressing means (6) for applying a variable force or torque to the flexible element (5), wherein the actuation system (20) comprises an eccentric (10) actuating the prestressing means (6) of the adjustment means (30).

2. The regulating member according to claim 1, wherein the eccentric (10) is rotatably mounted through the balance cock (22).

3. The regulating member according to claim 1, wherein the eccentric (10) comprises a head (21) and a main body (11) extending from the head (21).

4. The regulating member according to claim 3, wherein the eccentric (10) further comprises a finger (12) extending from the main body (11), the finger (12) being off-centred relative to the main axis of the main body (11) of the eccentric (10).

5. The regulating member according to claim 3, wherein the head (21) comprises a recess (18) intended to receive the tip of a tool for actuating the eccentric (10).

6. The regulating member according to claim 1, wherein the prestressing means (6) comprise a movable first lever (14) connected to the flexible element (5), with the eccentric (10) being in direct or indirect contact with the lever (14) in order to be able to actuate it.

7. The regulating member according to claim 6, wherein the prestressing means (6) comprise a second movable lever connected to the flexible element (5), with the eccentric (10) being in direct or indirect contact with the second lever (26) in order to be able to actuate it.

8. The regulating member according to claim 6, wherein the prestressing means (6) comprise a movable body (19) connected to the first lever (14) and/or to the second lever (26), with the finger (12) being in contact with the movable body (19).

9. The regulating member according to claim 8, wherein the finger (12) comprises a peripheral groove (33) cooperating with the movable body (19).

10. The regulating member according to claim 1, wherein the actuation system (20) comprises a stud-holder (31) comprising a stud (34) on which the balance spring (25) is mounted, the stud (34) being mechanically linked to the resilient element (5) of the balance spring (25).

11. The regulating member according to claim 1, wherein the stud-holder (31) is arranged on the balance cock (22) around a bearing (28) on the balance staff (24).

12. A horological movement, comprising the regulating member (1) according to claim 1.

13. A timepiece comprising the horological movement according to claim 12.
